(19) United States
(12) Patent Application Publication
(10) Pub. No.: US 2003/0105961 A1
(43) Pub. Date: Jun. 5, 2003

(54) Avoiding attachment of an ineligible smart interchangeable cover to an electronic device

(76) Inventors: Peter Zatloukal, Duvall, WA (US); G. Eric Engstrom, Kirkland, WA (US); Paul R. Nash, Bellevue, WA (US); David L. Pike, Seattle, WA (US)

Correspondence Address: SCHWABE, WILLIAMSON & WYATT, P.C., PACWEST CENTER, SUITES 1600-1900, 1211 SW FIFTH AVENUE, PORTLAND, OR, 97204, US

(21) Appl. No.: 10/000,170

(22) Filed: Nov. 30, 2001

(51) Int. Cl. H04L 9/00

(52) U.S. Cl. 713/170

(57) ABSTRACT

A base portion of an electronic apparatus and a plurality of eligible smart interchangeable covers are provided with corresponding instructions for the base to authenticate an attached cover. The base operates the apparatus at a function/feature level in view of whether the base is able to authenticate the cover. In one embodiment, the authentication involves exchange of challenges and responses between the base and the cover, employment of session keys to facilitate the exchanges via encrypted communications, employment of private and public keys of the cover to facilitate provision of the session key(s) to the cover, and employment of a certificate to facilitate provision of the public key of the cover to the base. In one embodiment, the challenges/responses comprise at least a subset of the functions/features implementing instructions/data of the cover, and the certificate is signed by a common licensor of the vendors of the base and the covers.

### BACKGROUND OF THE INVENTION

1. Field of the Invention

The present invention relates to the field of counterfeit avoidance techniques. More specifically, the present invention relates to the avoidance of attachment of an ineligible (such as, counterfeit) smart interchangeable cover to a base portion of an electronic apparatus (to personalize or functionally enrich the electronic apparatus).

2. Background Information

With the proliferation of electronic devices, especially mobile electronic devices, such as, mobile phones, hand-held personal computers, and so forth, these devices have gained the status of personal appliances to a person. As a result, increasingly, users desire to personalize these devices. For example, in addition to a wide variety of body casing colors, interchangeable faceplates of various colors and artistic designs are available for a variety of mobile phones to allow the users to have even greater choices providing different physical appearances to their own devices. Additionally, a variety of non-standard features such as games, screen-savers and ring tones can be downloaded from various websites into the devices to further personalize the devices. Similarly, hand-held personal computers and personal digital assistants also come in various colors, with various applications software, screen savers and wallpapers. In this document, the terms “personalization feature” or “feature” are used interchangably to refer to these types of software programs and/or data and the effects they may have on the appearance or functionality of a device. In this definition, items such as games, screensavers or ringtones are illustrative and not the exclusive types of features that may be included in the meaning of “personalization feature.”

These approaches to personalization suffer from a number of disadvantages. First, they are disjoint. Typically, a user may go to a mall or an online e-commerce site to shop and purchase, e.g. a faceplate with design and/or color that is of interest to the user. Then, the user may go online to websites to search and look for a custom ring tone or a screen saver of interest to the user. It is the user's responsibility to choose and combine the appropriate hardware, i.e. faceplate design/color, with the software behavior, i.e. custom ring tone etc. to create a total personality. The process is cumbersome for many users, especially for the more novice users, as the proliferation of mobile electronic devices reaches more and more users. Moreover, the approaches do not facilitate quick and timely changes to the personality to be taken on by the mobile electronic devices. These shortcomings apply equally to personalization of other electronic devices, such as game consoles.

In co-pending U.S. Provisional Application No. 60/306,326, titled “Personalizing Electronic Devices and Smart Covering”, filed on Jul. 17, 2001, various methods and apparatus for personalizing or field enhancing the functionalities of electronic devices are disclosed. While these methods and apparatus brought forth numerous benefits and advantages, they also give rise to a need to prevent ineligible (such as counterfeit) smart interchangeable covers from being inappropriately employed.

Thus, methods and apparatuses that can secure and avoid attachment of ineligible (such as counterfeit) smart interchangeable covers to electronic devices are desired. As those skilled in the art would appreciate, sophisticated security measures are costly to implement. Moreover, theoretically, even the most sophiscated commercial security measures may be compromised, given sufficient resource and time. Thus, it is further desired that the security and avoidance method provides a sercurity versus cost tradeoff that is commensurate to both the security needs and the economics of the electronic apparatuses on which the methods are practiced.

### SUMMARY OF THE INVENTION

A base portion of an electronic apparatus and a plurality of eligible smart interchangeable covers are provided with corresponding plurality of instructions for the base portion to authenticate a smart interchangeable cover attached to the base portion at power on or reset, or at any other appropriate point in time, as determined by the base portion or the smart interchangeable cover. The base portion operates the electronic apparatus at a function or feature level in view of whether the base portion is able to authenticate the attached smart interchangeable cover or not, selectively enabling/disabling functions/features of the base portion and the attached smart interchangeable cover.

In one embodiment, the base portion would accept data from the smart interchangeable cover (e.g. to personalize or enhance the functions/features of the electronic apparatus), only if the smart interchangeable cover has been authenticated.

In one embodiment, the base portion would operate with at least one of the functions/features offered by the based portion and the smart interchangeable cover at least partially disabled or degraded if the base portion was not able to authenticate the smart interchangeable cover.

In one embodiment, the base portion authenticates the attached cover by challenging the attached cover with one or more challenges, and verifying that the attached cover is able to respond to the one or more challenges with proper responses. In one embodiment, the challenges and responses are exchanged over a secured communication sessions using a set of one or more session keys (SK).

In one embodiment, the set of one or more SKs are generated by the base portion and provided to the attached cover. In one embodiment, the SKs are provided to the attached cover in an encrypted form, using a public key of the attached cover (CvrKpu). In one embodiment, CvrKpu is provided to the base portion in a signed form using a private signing key (CertSignKpr) of the certification authority and by ways of a certificate signed by a certification authority using a private master key (CertMstrKpr) of the certification authority, and the base portion extracts CvrKpu using a corresponding public signing key (CertSignKpu) of the certification authority, as well as verifying the certificate using a corresponding public master key of the certification authority (CertMstrKpu).

In one embodiment, the subsequent challenges are dependent on the predecessor challenges. In one embodiment, the challenges and responses involve the implementing instructions/data of the functions/features of the attached cover. In one embodiment, the first challenge includes having the attached cover provides the base portion with a manifest enumerating implementing instructions/data of the functions/features of the attached cover, and a signature of the manifest signed by the certification authority, and the second challenge includes having the attached cover provides the base portion with at least one of the functions/features enumerated in the manifest.

In one embodiment, the certification authority is a common licensor, licensing respective manufacturing rights to the vendors of the base portion and attached cover. In one embodiment, the certification authority may revoke previously signed public keys of “once eligible” smart covers, by revoking previously published public signing keys.

In one embodiment, the base portion may employ the assistance of a remote server in authenticating an attached cover. In one embodiment, the base portion may temporarily consider the attached cover as being temporarily authenticated, until it receives the determination or information contributing to the determination from the assisting remote server.

### BRIEF DESCRIPTION OF DRAWINGS

The present invention will be described by way of exemplary embodiments, but not limitations, illustrated in the accompanying drawings in which like references denote similar elements, and in which:

FIG. 1 illustrates an overview of the present invention, in accordance with one embodiment;

FIG. 2 illustrates an internal component view of the base portion of the electronic apparatus of FIG. 1, in accordance with one embodiment;

FIG. 3 illustrates an internal component view of the interchangeable cover of FIG. 1, in accordance with one embodiment;

FIG. 4 illustrates the operational flow of the relevant aspects of the authentication logic of the base portion of the electronic apparatus of FIG. 1, in accordance with one embodiment;

FIG. 5 illustrates the operational flow of the relevant aspects of the authentication logic of the interchangeable cover of FIG. 1, in accordance with one embodiment;

FIG. 6 illustrates one example application of the present invention to wireless mobile phones; and

FIG. 7 illustrates another example application of the present invention to personal digital assistants.

### DETAILED DESCRIPTION OF THE INVENTION

The present invention includes complementary authentication logics advantageously endowed to the base portion of an electronic apparatus and to their eligible interchangeable covers, to enable the base portion to authenticate an attached cover, to prevent counterfeit covers from being attached to the electronic apparatus.

In the following description, various aspects of the present invention will be described. For purposes of explanation, specific numbers, materials and configurations are set forth in order to provide a thorough understanding of the present invention. However, the present invention may be practiced with only some of the described aspects, and without the specific details. In other instances, well-known features are omitted or simplified in order not to obscure the present invention.

The phrase “in one embodiment” will be used repeatedly, however the phrase does not necessarily refer to the same embodiment, although it may. Further, the terms “comprising”, “having”, “including” and the like are synonymous.

### Overview

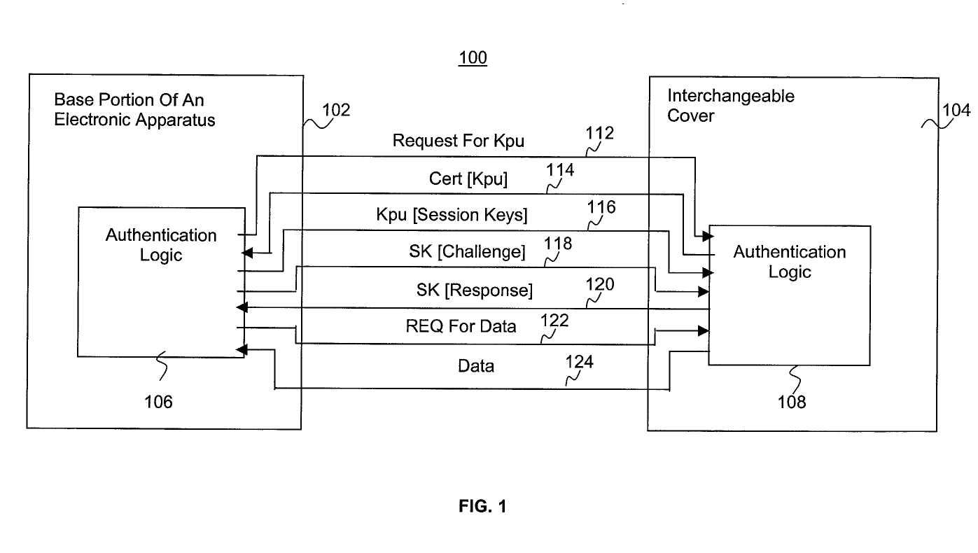

Referring now to FIG. 1, wherein a block diagram illustrating an overview of the present invention, in accordance with one embodiment, is shown. As illustrated, base portion 102 of electronic apparatus 100 and eligible smart interchangeable cover 104 are endowed with authentication logic 106 and 108 respectively, to cooperate with each other to effectuate the desired authentication and avoidance of counterfeit covers. For the illustrated embodiment, upon detecting the initial presence of smart cover 104 (at e.g. power on or reset or any arbitrary point in time selected by either base portion 102 or smart cover 104), authentication logic 106 of base portion 102 is given execution control, which in turn prompts smart cover 104 for certain information and challenges smart cover 104 to authenticate smart cover 104. Thereafter, base portion 102 operates electronic apparatus 100 with smart cover 104 attached at a function/feature level consistent with whether base portion 102 is able to authenticate the attached smart cover 104.

In one embodiment, if authentication logic 106 is able to successfully authenticate smart cover 104, base portion 102 proceeds to operate apparatus 100, enabling all the functions and features base portion 102 and smart cover 104 have to offer, less function and features loaded into base portion 102 that are to be enabled only with the presence of particular covers. However, if authentication logic 106 is unable to successfully authenticate smart cover 104, base portion 102 proceeds to operate apparatus 100, disabling at least partially one of the functions/features base portion 102 and smart cover 104 have to offer.

In one embodiment, base portion 102 would request 122 and accept the data 124 of smart cover 104 (for personalizing and/or enhancing the functions/features of apparatus 100) only if it is able to authenticate smart cover 104. In another embodiment, base portion 102 would request 122 and accept the data 124 of smart cover 104, even if base portion 102 fails to authenticate smart cover 104. However, base portion 102 would not fully enable or not enable at all the functions/features implemented by the accepted data 124. In yet other embodiment, in addition to or in lieu of the aforementioned remedial actions, and disabling functions/features that require presence of certain covers, base portion 102 further partially or fully disable one or more of its own functions/features, if it fails to authenticate attached smart cover 104, e.g. in the case of a wireless mobile phone application, disabling all functions, except for the ability to place an emergency call, or a call to the service center of a carrier.

As will be described in more detail below, in one embodiment, authentication logic 106, authenticates cover 104, with the cooperation of authentication logic 108, involving one or more challenges 118 and responses 120 between base portion 102 and cover 104. In one embodiment, the challenges 118 and responses 120 are exchanged over a secured communication session, using a set of one or more session keys (SK) generated by authentication logic 106.

In one embodiment, the SKs are provided to authentication logic 108 in an encrypted form 116, employing a public key (CvrKpu) of cover 104, which has a corresponding private key (CvrKpr). In one embodiment, the public key CvrKpu of cover 104 is provided to authentication logic 106 in a signed form using a private signing key (CertSignKpr) of a certification authority, and via a certificate 114 signed by the certification authority using its private master key (CertMstrKpr).

In one embodiment, successor challenges are dependent on predecessor responses. In one embodiment, the challenges and responses involve at least a subset of the implementing instructions/data of the functions/features of attached smart cover 104. In one embodiment, the first challenge includes having authentication logic 108 provides authentication logic 106 a manifest enumerating the implementing instructions/data of the functions/features of attached smart cover 104, and their corresponding hash values, and a signature of the manifest. In one embodiment, the signature of the manifest is generated by a certification authority.

In one embodiment, the certification authority is the common licensor, licensing respective manufacturing rights to vendors of base portion 102 and eligible smart covers 104. In one embodiment, the certification authority may revoke previously signed CvrKpus of “once eligible” smart covers 104 by revoking previously published public signing keys, thereby expiring “once eligible” smart covers 104. In one embodiment, authentication logic 106 may be assisted by a remote server (if base portion 102 is equipped with appropriate communication capability). In one embodiment where authentication logic 106 is assisted by a remote server, authentication logic 106 may temporarily consider smart cover 104 to be authenticated, until it receives the determination or information contributing to the determination from the assisting remote server.

Except for the respective endowment of authentication logic 106 and 108 to base portion 102 and eligible covers 104, electronic apparatus 100 may be any one of a wide range of electronic apparatuses, in particular, personal electronic apparatuses, that are amenable to personalization and/or field upgrade of the base portions or base units' functions or features. These electronic apparatuses include but are not limited to pagers, personal digital assistants, wireless mobile phones, game consoles, and so forth.

Personalizing and/or enhancing the functions/features of a base electronic apparatus through smart interchangeable covers is the subject matter of the earlier identified U.S. Provisional Application '326. The specification of which is hereby fully incorporated by reference.

As noted in the incorporated by reference application, the term “wireless mobile phone” as used (in the specification and in the claims) refers to the class or classes of telephone devices (both analog and digital) equipped to enable a user to make and receive calls wirelessly, notwithstanding the user's movement, as long as the user is within the “covered or service area”, i.e. within the communication reach of a service or base station of a wireless network. The scope of the “covered or service area” and the signaling protocol are both service provider dependent.

### Method of Operation

Still referring to FIG. 1, a method of operation of the present invention in accordance with one embodiment, is illustrated. As shown, upon given execution control in response to the detection of the presence or removable attachment of smart cover 104, during power on or reset (or any arbitrary point in time, selected by either base portion 102 or attached smart cover 104), for the embodiment, authentication logic 106 of base portion 102 requests smart cover 104 to supply one or more public keys (CvrKpu) of smart cover 104. In response, authentication logic 108 of authentic smart cover 104 provides the CvrKpu or CvrKpus as requested.

In one embodiment, one CvrKpu is provided, for use by authentication logic 106 to provide SK/Sks to smart cover 104 as well as for use by authentication logic 106 to verify one or more signatures associated with the responses of authentication logic 108 to challenges posed by authentication logic 104. In one embodiment, at least two CvrKpus are provided, with one CvrKpu for use by authentication logic 106 to provide SK/SKs to smart cover 104, and another CvrKpu for use by authentication logic 106 to verify one or more signatures associated with the responses of authentication logic 108 to challenges posed by authentication logic 104.

In one embodiment, authentication logic 108 of smart cover 104 provides the CvrKpu or CvrKpus by way of one or more certificates signed by a certification authority. In one embodiment, each CvrKpu is signed by a private signing key of the certification authority (CertSignKpr), and each certificate is in turn signed by a private master key of the certification authority (CertMstrKpr).

As described earlier, in one embodiment, the authentication authority is a common licensor, licensing respective manufacturing rights to vendors of base portion 102 of the electronic apparatus and eligible smart interchangeable covers 104.

Authentication logic 106 of base portion 102, upon receipt of each certificate, extracts the CvrKpu from the received certificate, using a corresponding public signing key of the certification authority (CertSignKpu), which is pre-provided to authentication logic 106. For the embodiment, authentication logic 106 further authenticates the received certificate, using a corresponding public master key of the certification authority (CertMstrKpu), which is also pre-provided to authentication logic 106. Recovery of CvrKpu and authentication of the received certificate are dependent on the actual encryption technique employed, which may be any one of a number of techniques known in the art. In one embodiment, the encryption technique employed is the RSA technique.

The key length is dependent on the robustness desired as well as storage capacity of smart cover 104 and/or base portion 102. In one embodiment, keys of 1024-bit key lengths are employed.

As alluded to earlier, in various embodiments, where base portion 102 is endowed with communication capability, base portion 102 may be provided with revocation information revoking a previously issued public signing key of the certification authority. Thus, even though authentication logic 106 is able to authenticate the certificate, for whatever operational reasons, authentication logic 106 may be prevented from being able to recover CvrKpu(s) of the attached smart cover 104. Accordingly, authentication logic 106 may be prevented from successfully completing the authentication process, and authenticating a “once eligible”, but now “expired” smart cover 104.

Upon authenticating the received certificate(s), for the embodiment, authentication logic 106 of base portion 102 generates a set of one or more session keys (SKs) for authentication logic 108 of smart cover 104 to be employed for all subsequent authentication related communications. Authentication logic 106 of base portion 102 encrypts the generated set of one or more SKs using the provided CvrKpu (or an appropriate one of the provided CvrKpus), and provides the SKs to authentication logic 108 of smart cover 104 in an encrypted form.

Authentication logic 108 of smart cover 104, upon receipt of the encrypted SKs, decrypts and recovers the SKs, using a corresponding private key CvrKpr.

In one embodiment, the 3DES encryption technique is employed to facilitate the exchanges of challenges and responses between authentication logics 106 and 108. For the embodiment, the set of one or more Sks includes at least 3 session keys. In alternate embodiment, more or less SKs as well as other symmetric or non-symmetric encryption techniques may be practiced instead.

Thereafter, for the embodiment, authentication logic 106 generates a first challenge for authentication logic 108. The first challenge is provided to authentication logic 108 in encrypted form using the previously provided SKs, thereby increasing the difficulties or burden in the manufacturing of any counterfeit or ineligible smart covers 104. As alluded to earlier, in one embodiment, the challenges involve implementing instructions/data of functions/features of attached smart cover 104. More specifically, the first challenge includes having authentication logic 108 provides authentication logic 106 with a manifest enumerating the implementing instructions/data of the functions/features of smart cover 104 and their corresponding hash values, and a signature of the manifest generated by the certification authority.

Then, authentication logic 108 of smart cover 104 provides a response to the challenge (generating the response if necessary). For the embodiment, authentication logic 108 of smart cover 104 provides the response to authentication logic 106 of base portion 102 in an encrypted form, encrypting the response using the provided session SKs.

Upon receipt of the encrypted response, authentication logic 106 of base portion 102 decrypts and recovers the response, using the SKs. Upon recovering the response, authentication logic 106 of base portion 102 determines the “correctness” of response. For the embodiment, authentication logic 106 verifies the manifest using the provided CvrKpu of smart cover 104 or an appropriate one of the provided CvrKpus of smart cover 104. That is, authentication logic 106 independently generates a hash value for the plaintext of the provided manifest, recovers the reference hash value from a signed hash value provided with the manifest, using the provided CvrKpu, and compares the two hash values.

For the embodiment, as alluded to earlier, subsequent challenges are dependent on predecessor responses. More specifically, upon verifying the signature of the manifest, authentication logic 106 poses another challenge to authentication logic 108, again in an encrypted form, using the generated SKs. For the embodiment, the second challenge includes having authentication logic 108 provides one or more of the enumerated implementing instructions/data of the functions/features of smart cover 104. In one embodiment, authentication logic 106 selects which enumerating implementing instructions/data to request in a random manner, to increase unpredictability.

In like manner, authentication logic 108 provides the requested one or more implementing instructions/data in encrypted form, using the provided SKs. Authentication logic 106, upon recovering the provided instructions/data, in turn independently generates a check hash value for each of the provided implementing instructions/data, and compares each of the generated check hash value to the corresponding hash value earlier provided as part of the signed manifest, to determine whether authentication logic 108 properly responded to the challenge(s).

In various embodiments, authentication logic 106 of base portion 102 may repeat the above described challenge and response process a number of times to satisfy itself that attached smart cover 104 is an eligible or authentic smart cover. The number of repetitions may be fixed or variable, guided by a number of heuristic or other factors.

Upon being satisfied with the authenticity of attached smart cover 104, base portion 102 signals attached smart cover 104 that it is ready to accept data from smart cover 104. In response, smart cover 104 provides base portion 102 with its embedded data (to personalize or enhance the functions/features of apparatus 100).

In various embodiments where base portion 102 is equipped with appropriate communication capabilities, authentication logic 106 may enlist one or more remote servers to assist in authenticating attached smart cover 104. For some or all of these embodiments, authentication logic 106 may further temporarily assume attached smart cover 104 as being authenticated and operate base portion 102 and attached smart cover 104 accordingly, until it receives the determination or the information to assist authentication logic 106 to make the determination from the assisting remote server or servers.

### Base Portion

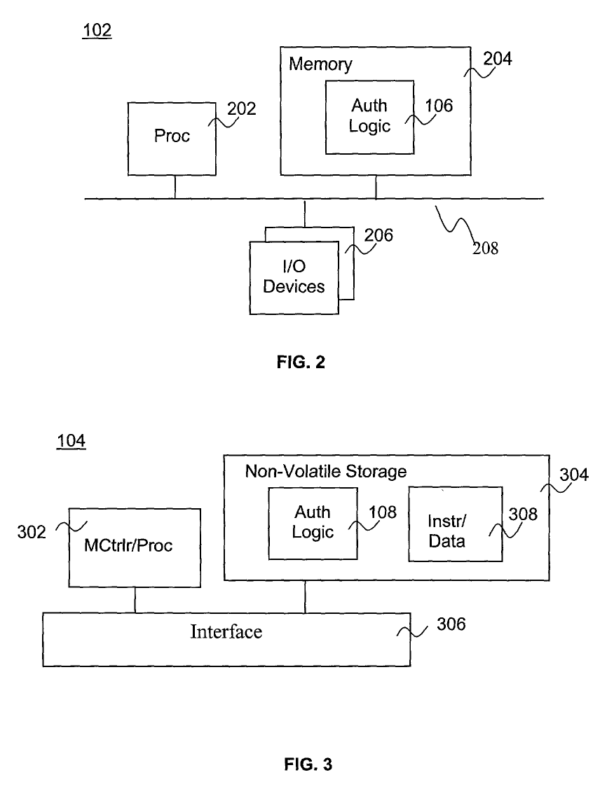

FIG. 2 illustrates a component view of base portion 102 of electronic apparatus 100, in accordance with one embodiment. As illustrated, apparatus 100 includes elements found in conventional mobile client devices, such as microcontroller/processor 202, non-volatile memory 204, and general purpose input/output (GPIO) interface 206, coupled to each other via bus 208. In one embodiment, apparatus 100 is a wireless mobile phone, including also elements such as digital signal processor (DSP), transmit/receive (TX/RX) 312, and so forth (not shown).

GPIO 206 is used to attach a number of I/O devices to apparatus 100, including in particular smart cover 104. Non-volatile memory 204 is used to store programming instructions and data, including in particular, authentication logic 106 and any data (to personalize or enhance the functions/features of apparatus 100) accepted from smart cover 104. Except for these uses, the elements are used to perform their conventional functions known in the art, e.g. processor 202 for executing instructions. In the case of a wireless mobile phone, the included DSP and TX/RX are employed to send and receive as well as processing signals, in support of one or more of the known signaling protocols, including but are not limited to CDMA, TDMA, GSM, and so forth. The constitutions of these elements are known. Accordingly, the elements will not be further described.

### Smart Cover

FIG. 3 illustrates a component view of smart interchangeable cover104 of electronic apparatus 100, in accordance with one embodiment. As illustrated, for the embodiment, smart cover 104 includes micro-controller/processor 302 non-volatile storage 304, and interface 306, coupled to each other. Micro-controller/processor 302 performs its conventional functions known in the art. Non-volatile storage 304 is used to host authentication logic 108 and data 308 for personalizing or enhancing the functions/features of apparatus 100. Non-volatile storage 304 may be EEPROM, flash, memory or combinations thereof. In one embodiment, inteface 306 is in the form of a number of contact pins forming a serial or a parallel interface. In one embodiment, one of the contact pins is used to supply power to components 302-306 of smart cover 104. In alternate embodiment, other types of interfaces may be used instead.

### Operation Flow of Base Portion Authentication Logic

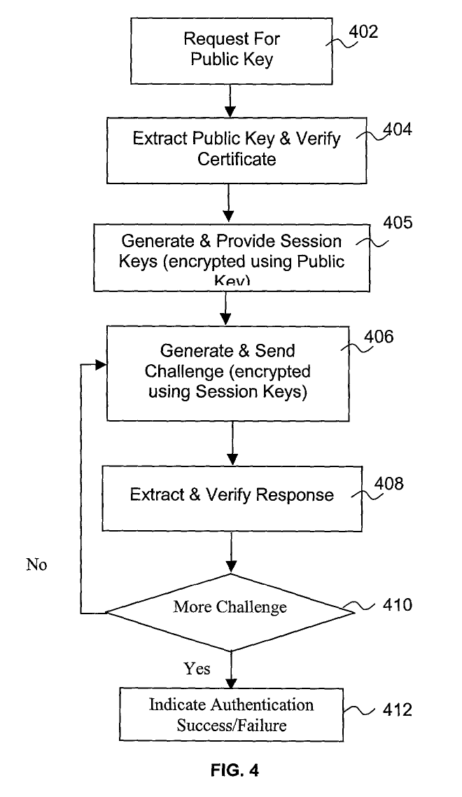

FIG. 4 illustrates the operational flow of the relevant aspects of authentication logic 106 of FIG. 1, in accordance with one embodiment. As illustrated and alluded to earlier, upon given execution control, authentication logic 106 requests for a public key CvrKpu, block 402. Thereafter, authentication logic 106 waits for the response of smart cover 104. After a certain period of time has passed without a response from attached smart cover 104, authentication logic 106 may determine an authentication error has occurred, and discontinue waiting, in which case smart cover 104 is considered ineligible.

Eventually, authentication logic 106 receives the response. For the embodiment, it is assumed that if smart cover 104 is an eligible smart cover, the response will be in the form of a certificate signed by an authentication authority (which in one embodiment is their common licensor) with the requested CvrKpu being embedded therein. Accordingly, upon receipt of the certificate, authentication logic 106 extracts CvrKpu using CertSlgnKpu, block 404. For the embodiment, as alluded to earlier, authentication logic 106 further verifies the certificate using CertMstrKpu.

Assuming the certificate is verified, authentication logic 106 generates a set of SKs to facilitate subsequent exchanges of challenges and responses between authentication logics 106 and 108, encrypts the SKs using the provide CvrKpu or an appropriate provided one of the CvrKpus, and provides the SKs in an encrypted form to authentication logic 108, block 405.

Then, authentication logic 106 provides a challenge, encrypting the challenge using the provided CvrKpu or an appropriate one of the provided CvrKpus, and transmits the encrypted challenge to smart cover 104, block 406. Thereafter, authentication logic 106 again waits for the response of smart cover 104.

Eventually, authentication logic 106 receives the response to the challenge it posed. For the embodiment, the response to the challenge is returned in an encrypted form using the provided SKs. Accordingly, upon receipt of the encrypted response to the challenge, authentication logic 106 recovers the response, decrypting the encrypted response using the generated Sks, and then verifies the recovered response, block 408. In one embodiment, as described earlier, verification includes verifying the signature of a manifest of smart cover 104 for a first response to a first challenge using CvrKpu, and verifying hash values of implementing instructions/data of smart cover 104 for later responses to subsequent challenges.

At block 410, authentication logic 106 determines whether smart cover 104 has successfully responded to sufficiently number of challenges to be considered as an eligible cover.

Eventually, smart cover 104 has either successfully responded to a sufficient number of challenges to be considered as an eligible cover, or has failed to respond to a point that the smart cover is to be considered as ineligible. At such time, authentication logic 106 generates an indication for base portion 102 denoting whether attached smart cover 104 is to be considered as an eligible or ineligible cover, block 412.

Thereafter, as described earlier, in one embodiment, base portion 102 proceeds to request smart cover 104 for its data (to personalize or enhance the functions/features of apparatus 100), if the indication generated by authentication logic 104 denotes that smart cover 104 is an eligible cover. In one embodiment, base portion 102 simply ignores the attached smart cover 104 if the indication generated by authentication logic 104 denotes that smart cover 104 is an ineligible cover.

### Operation Flow of Base Portion Authentication Logic

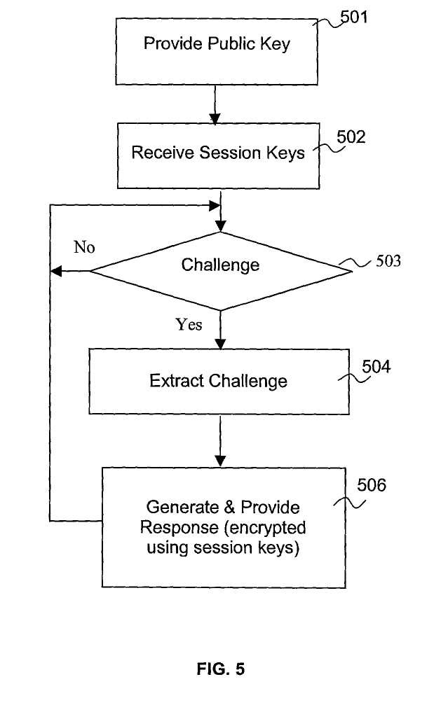

FIG. 5 illustrates the operational flow of the relevant aspects of authentication logic 108 of FIG. 1, in accordance with one embodiment. As illustrated, for the embodiment, upon receipt of a request for a CvrKpu from base portion 102 to which smart cover 104 is attached, authentication logic 108 provides authentication logic 106 of base portion 102 a CvrKpu corresponding to its CvrKpr (in a signed form and by way of a signed certificate), block 501. Next, for the embodiment, authentication logic 108 receives a set of SKs from authentication logic 106, to facilitate subsequent exchanges of challenges and responses between authentication logics 106 and 108, block 502. Thereafter, authentication logic 108 waits for a challenge from authentication logic 104 of base portion 102.

Eventually, authentication logic 108 receives the challenge encrypted using the SKs, as described earlier. In response, authentication logic 108 decrypts the encrypted challenge using the provided SKs, block 504. Upon recovering the challenge, authentication logic 108 provides a response to the challenge (generating it if necessary). For the embodiment, authentication logic 108 encrypts the response using the SKs, and provides the encrypted response as its reply to the challenge posted by authentication logic 106, block 506. Thereafter, authentication logic 108 waits for another challenge from authentication logic 104 of base portion 102.

Assuming eventually, authentication logic 104 is satisfied that attached smart cover 104 is an eligible cover, and ceases to pose further challenges.

As described earlier, in one embodiment, base portion 102 then proceeds to request for the implementing instructions/data of the functions/features of smart cover 104 (to personalize or enhance the functions/features of apparatus 100). In response, smart cover 104 provides its functions/features' implementing instructions/data as requested.

### EXAMPLE APPLICATIONS

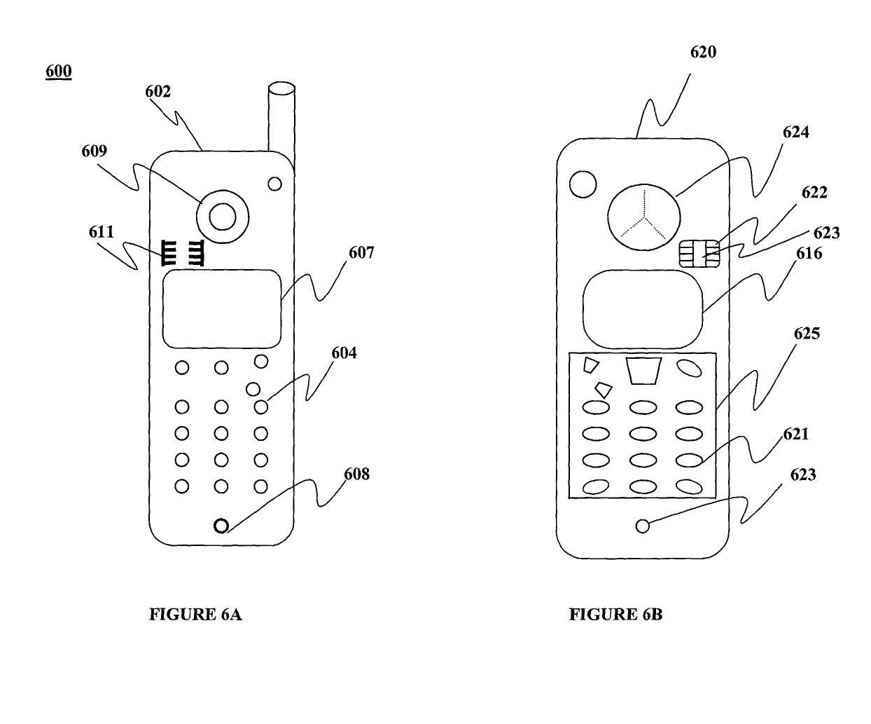

FIGS. 6a-6b illustrate an example application of the present invention to a wireless mobile phone, in accordance with one embodiment. Shown in FIG. 6a is an exposed view of wireless mobile phone 600, without its cover, exposing its base portion 602. Shown in FIG. 6b is a complementary smart interchangeable cover 620, designed for attachment to, and covering base portion 602 of wireless mobile phone 600. Further, smart interchangeable cover 620 comprises implementing instructions/data to personalize and/or enhance the functionalities of wireless mobile phone 600.

The orientation of the illustrations in FIGS. 6a-6b is that the right side of base portion 602 corresponds to (or engages with) the left side of smart interchangeable cover 620, and the left side of base portion 602 corresponds to (or engages with) the right side of the interchangeable covering 620.

Base portion 602 includes contacts 604 that are pressed by a keypad 625 formed with keys 621 molded onto smart interchangeable cover 620. Additionally, the base portion also includes a display, such as, a liquid crystal display (LCD) 607, a microphone 608, and a speaker 609. LCD 607 corresponds to a transparent area or cutout 616 to facilitate exposure of a graphical user interface. Speaker 609 and microphone 608 correspond to the audio transmissive area for sound transmission 624, and the audio transmissive area for sound reception 623, respectively on smart interchangeable cover 620, for audio transmission and receipt.

Smart interchangeable cover 620 includes electronic component 623 having the earlier described data and/or programming instructions for personalizing or enhancing the functionalities of wireless mobile phone 600. Electronic component 623 includes contacts 622 designed to mate with contacts 611 of base portion 602.

In one embodiment, the data and/or programming instructions provide a customized ring tone complementary to an aspect of a personalizing theme conveyed by the design and color of cover 620. Additionally, the data and/or programming instructions include address specifications designating locations on a network where additional data and/or programming instructions for further personalizing or enhancing the functionalities may be retrieved. The address specifications may be in the form of one or more Uniform Resource Locators (URLs).

From hereon forward (including the claims), for ease of understanding, “data and/or programming instructions” will simply be referred to as “data”. Usage of the term “data” includes “data” as it is conventionally used, and/or “programming instructions”, unless the implicit optional inclusion of “programming instructions” is explicitly excluded.

Smart interchangeable covering 620 in FIG. 6b is shown as substantially similar in shape, length, and width to wireless mobile phone 600. However, smart interchangeable covering 620 may be of any shape and size to cover all or portions of wireless mobile phone 600, such as, but not limited to, an interchangeable covering that covers only a portion of the wireless mobile phone 600. Smart interchangeable cover 620 may cover only the face of wireless mobile phone 600. Additionally or alternatively, it may cover the sides of wireless mobile phone 600 or portions thereof. Smart interchangeable cover 620 may also cover the back of wireless mobile phone 600 or portions thereof.

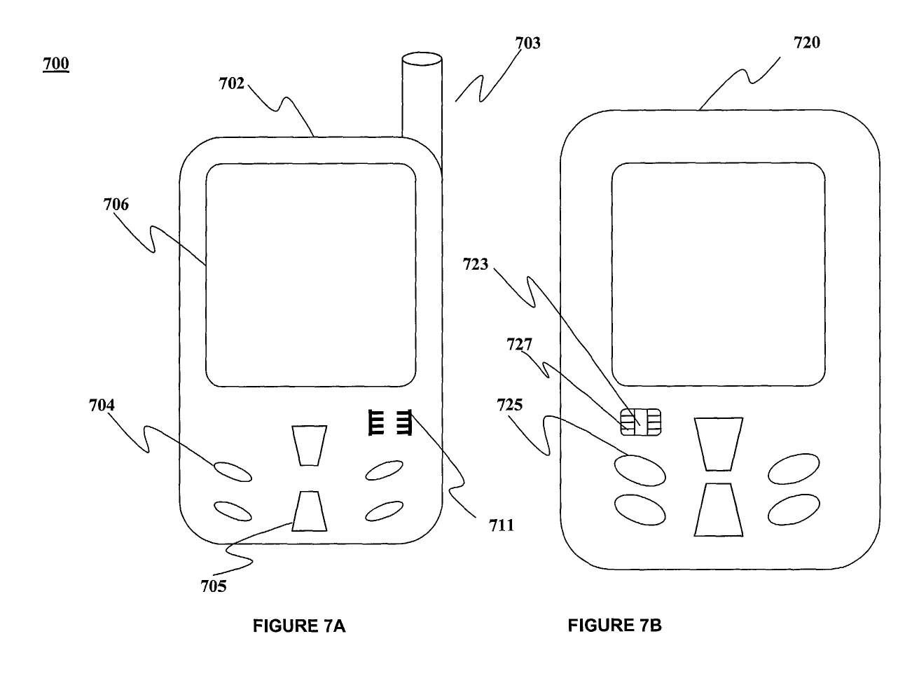

FIGS. 7a-7b illustrate another example application of the present invention to a personal digital assistant, in accordance with one embodiment. Shown in FIGS. 7a-7b, is a personal digital assistant (PDA) 700 (also referred to as handheld personal computer or handheld PC) with its cover removed, and a complementary smart interchangeable cover 710.

Similar to the earlier described wireless mobile phone application, base portion 702 of PDA 700 includes various buttons 704 and 705 for activating certain functions, such as, but not limited to, scrolling through displayed information, LCD 706 to display the information and form a graphical interface, and, optionally, antenna 703 to receive and transmit data from the exposed PDA 700. Shown also, disposed on smart interchangeable covering 720, are various openings 725 to allow the various buttons 704 and 705 to be pressed through interchangeable PDA cover 720.

Smart interchangeable cover 720 also includes electronic component 723 having the earlier described data and/or programming instructions for personalizing or enhancing the functionalities of PDA 700. Electronic component 723 also includes contacts 727 designed to mate with contacts 711 of base portion 702.

More importantly, as the earlier described wireless mobile phone application, both the base portion and the cover are endowed with the complementary authentication logics of the present invention for the base portion to authenticate the cover, before accepting personalizing and/or function enhancing data from the cover.

### CONCLUSION AND EPILOGUE

Thus, a method and apparatus for avoiding counterfeit attachment of a smart interchangeable cover to a base portion of an electronic apparatus has been described. While the present invention has been described in terms of the above-illustrated embodiments, those skilled in the art will recognize that the invention is not limited to the embodiments described. The present invention can be practiced with modification and alteration within the spirit and scope of the appended claims. For examples, the specific encryption/decryption technique used in a specific stage of the authentication process, and the kind, the number as well as the length of keys used may also vary from embodiments to embodiments. Likewise, the nature of challenges and responses, and the resulting operational states of the apparatus may all vary from embodiments to embodiments. Thus, the description is to be regarded as illustrative instead of restrictive on the present invention.

What is claimed is:

1. In a base portion of an electronic apparatus, a method of operation comprising:
detecting for presence of a removably attached interchangeable cover;
authenticating the removably attached interchangeable cover as an eligible cover; and
operating the electronic apparatus, enabling/disabling all or selected functions/features offered by the base portion and the removably attached interchangeable cover in view of whether the removably attached interchangeable cover is authenticated.

2. The method of claim 1, wherein said authenticating comprises
generating a first challenge;
providing said first challenge to said removably attached interchangeable cover;
receiving from the removably attached interchangeable cover a first response to the first challenge; and
verifying correctness of said received first response.

3. The method of claim 2, wherein said providing comprises providing said first challenge in a first encrypted form, and said authenticating further comprises encrypting said first challenge into said first encrypted form using a set of one or more session keys.

4. The method of claim 3, wherein said authenticating further comprises generating said set of one or more session keys, and pre-providing said generated set of one or more session keys to said removably attached interchangeable cover.

5. The method of claim 4, wherein said pre-providing comprises pre-providing said generated set of one or more session keys in a second encrypted form, and said authenticating further comprises encrypting said generated set of one or more session keys into said second encrypted form using a public key of the removably attached interchangeable cover.

6. The method of claim 5, wherein said authenticating further comprises requesting and receiving said public key of the removably attached interchangeable cover from the removably attached interchangeable cover.

7. The method of claim 6, wherein said receiving of said public key of the removably attached interchangeable cover from the removably attached interchangeable cover comprises receiving said public key of the removably attached interchangeable cover in a signed form from the removably attached interchangeable cover, and said authenticating further comprises verifying said received public key as having been signed by an authorized party using a public signing key of a trusted certification authority.

8. The method of claim 7, wherein said verification of said received public key of the removably attached interchangeable cover as having been signed by an authorized party further comprises determining whether the public signing key has been revoked by the trusted certification authoring, and recovering said public key of the removably attached interchangeable cover as part of the verification process.

9. The method of claim 7, wherein the base portion of the electronic apparatus and the removably attached interchangeable cover are manufactured by a first and a second manufacturer respectively, and said trusted certification authority is a common licensor licensing respective manufacturing rights to said first and second manufacturers.

10. The method of claim 7, wherein said receiving of said public key of the removably attached interchangeable cover from the removably attached interchangeable cover comprises receiving a certificate signed by said trusted certification authority comprising said public key of the removably attached interchangeable cover, and said authenticating further comprises verifying said certificate using a public master key of the trusted certification authority.

11. The method of claim 2, wherein said first challenge comprises a challenge to provide the base portion with a data block and a signature of the data block, said first response comprises the data block and the corresponding signature requested, and said verification comprises verifying correspondence of the provided data block to the provided signature using a public signing key corresponding to a private signing key employed to generate the signature of the data block.

12. The method of claim 11, wherein said verification of correspondence comprises recovering said corresponding public signing key using a public signing key of a certification authority, generating a hash value for the received data block, generating a check signature based on the generated hash value and the recovered public signing key, and comparing the check signature and the provided signature of the data block.

13. The method of claim 11, wherein said data block comprises a manifest describing implementing instructions of at least a subset of the functions/features of the removably attached interchangeable cover.

14. The method of claim 2, wherein the method further comprises
generating a second challenge;
providing said second challenge to said removably attached interchangeable cover;
receiving from the removably attached interchangeable cover a second response to the second challenge; and
verifying correctness of said received second response.

15. The method of claim 14, wherein said second challenge is based at least in part on said first response.

16. The method of claim 15, wherein
said first challenge comprises providing the base portion with a manifest describing implementing instructions of at least a subset of the functions/features of the removably interchangeable cover and corresponding hash values, and a signature of the manifest;
said second challenge comprises providing the base portion with the described implementing instructions of at least one of functions/features of the removably attached interchangeable cover; and
said verification of the second response comprises generating a compare hash value for each of the at least one functions/features of the removably attached interchangeable cover provided, and comparing each of the generated compare hash values to the corresponding hash value previously provided as part of the signed manifest.

17. The method of claim 1, wherein said method further comprises requesting and receiving implementing instructions/data of a personalization feature from the removably attached interchangeable cover to personalize the electronic apparatus.

18. The method of claim 1, wherein said method further comprises requesting and receiving implementing instructions/data of a function from the removably attached interchangeable cover to enrich the functions of the electronic apparatus.

19. The method of claim 1, wherein said enabling/disabling comprises disabling functions/features previously loaded into the base portion that are to be enabled only with the presence of particular interchangeable covers.

20. The method of claim 1, wherein said enabling/disabling comprises disabling selected ones of the functions/features of the base portion if the removably attached interchangeable cover is not authenticated.

21. In an interchangeable cover removably attachable to a base portion of an electronic apparatus, a method of operation comprising:
receiving a first challenge from a base portion of an electronic apparatus to which to interchangeable cover is removable attached, to facilitate the base portion in determining that the interchangeable cover is an eligible cover; and
in response, generating and providing the base portion with a first response to said first challenge to facilitate the base portion in making said determination.

22. The method of claim 21, wherein said first challenge is received in a first encrypted form, and said method further comprises decrypting said first challenge using a set of one or more session keys.

23. The method of claim 22, wherein said method further comprises pre-receiving said set of one or more session keys from the base portion.

24. The method of claim 23, wherein said set of one or more session keys are received in a second encrypted form, and said method further comprises decrypting to recover said set of one or more session keys using a private key of the removably attached interchangeable cover corresponding to a public key of the removably attached interchangeable cover employed by the base portion to encrypt said set of one or more session keys.

25. The method of claim 24, wherein said method further comprises
receiving a request from the base portion for and said public key of the removably attached interchangeable cover; and
in response, providing said public key of the removably attached interchangeable cover to the base portion.

26. The method of claim 25, wherein said providing of said public key of the removably attached interchangeable cover comprises providing said public key of the removably attached interchangeable cover in a signed form, signed by an authorized party using a signing key of a trusted certification authority.

27. The method of claim 26, wherein the base portion of the electronic apparatus and the removably attached interchangeable cover are manufactured by a first and a second manufacturer respectively, and said trusted certification authority is a common licensor licensing respective manufacturing rights to said first and second manufacturers.

28. The method of claim 26, wherein said providing of said public key of the removably attached interchangeable cover comprises providing a certificate signed by said trusted certification authority comprising said public key of the removably attached interchangeable cover.

29. The method of claim 21, wherein said first challenge comprises a challenge to provide the base portion with a data block and a signature of the data block, and said first response comprises the data block and the corresponding signature requested, the signature being pre-generated using a private signing key.

30. The method of claim 29, wherein said data block comprises a manifest describing implementing instructions of at least a subset of the functions/features of the removably attached interchangeable cover.

31. The method of claim 21, wherein the method further comprises
receiving a second challenge from the base portion to further facilitate said base portion in determining eligibility of the interchangeable cover; and
in response, providing the base portion with a second response to the second challenge to further facilitate said base portion in determining eligibility of the interchangeable cover.

32. The method of claim 31, wherein said second challenge is based at least in part on said first response.

33. The method of claim 32, wherein
said first challenge comprises providing the base portion with a manifest describing implementing instructions of at least a subset of the functions/features of the removably interchangeable cover and corresponding hash values, and a signature of the manifest; and
said second challenge comprises providing the base portion with the described implementing instructions of at least one of functions/features of the removably attached interchangeable cover.

34. The method of claim 21, wherein said method further comprises receiving a request and in response, providing implementing instructions/data of a personalization feature from the removably attached interchangeable cover to personalize the electronic apparatus.

35. The method of claim 21, wherein said method further comprises receiving a request and in response, providing implementing instructions/data of a function from the removably attached interchangeable cover to enrich the functions of the electronic apparatus.

36. An apparatus comprising:
a base body case;
a processor encased within said base body case for use to execute instructions;
storage medium encased within said base body case, coupled to said processor, and having stored therein a plurality of instructions designed to implement a plurality of functions/features, to authenticate a removably attached smart interchangeable cover attached to the base body case as an eligible cover, and to operate the electronic apparatus, enabling/disabling all or selected ones of the implemented functions/features and functions/features offered by the removably attached smart interchangeable cover consistent with whether the removably attached smart interchangeable cover is authenticated.

37. The apparatus of claim 36, wherein said instructions enable the apparatus to authenticate a removably attached interchangeable cover by
generating a first challenge;
providing said first challenge to said removably attached interchangeable cover;
receiving from the removably attached interchangeable cover a first response to the first challenge; and
verifying correctness of said received first response.

38. The apparatus of claim 37, wherein said instructions enable the apparatus to effectuate said providing by providing said first challenge in a first encrypted form, and said authenticating further comprises encrypting said first challenge into said first encrypted form using a set of one or more session keys.

39. The apparatus of claim 38, wherein said instructions enable the apparatus to include as part of said authenticating, generation of said set of one or more session keys, and pre-providing of said generated set of one or more session keys to said removably attached interchangeable cover.

40. The apparatus of claim 39, wherein said instructions enable the apparatus to effectuate said pre-providing by pre-providing said generated set of one or more session keys in a second encrypted form, and include as part of said authenticating, encryption of said generated set of one or more session keys into said second encrypted form using a public key of the removably attached interchangeable cover.

41. The apparatus of claim 40, wherein said instructions enable the apparatus to include as part of said authenticating, request and receipt of said public key of the removably attached interchangeable cover from the removably attached interchangeable cover.

42. The apparatus of claim 41, wherein said instructions further enable the to receive said public key of the removably attached interchangeable cover in a signed form from the removably attached interchangeable cover, and include as part of said authenticating, verification of said received public key as having been signed by an authorized party using a public signing key of a trusted certification authority.

43. The apparatus of claim 42, wherein said instructions enable the apparatus to determine whether the public signing key has been revoked by the trusted certification authoring, and to recover said public key of the removably attached interchangeable cover as part of the verification process.

44. The apparatus of claim 43, wherein the base portion of the electronic apparatus and the removably attached interchangeable cover are manufactured by a first and a second manufacturer respectively, and said trusted certification authority is a common licensor licensing respective manufacturing rights to said first and second manufacturers.

45. The apparatus of claim 42, wherein said receiving of said public key of the removably attached interchangeable cover from the removably attached interchangeable cover comprises receiving a certificate signed by said trusted certification authority comprising said public key of the removably attached interchangeable cover, and said instructions further enable the apparatus to include as part of said authenticating, verification of said certificate using a public master key of the trusted certification authority.

46. The apparatus of claim 37, wherein said first challenge comprises a challenge to provide the base portion with a data block and a signature of the data block, said first response comprises the data block and the corresponding signature requested, and said instructions enable the apparatus to effectuate said verification by verifying correspondence of the provided data block to the provided signature using a public signing key corresponding to a private signing key employed to generate the signature of the data block.

47. The apparatus of claim 46, wherein said instructions enable the apparatus to effectuate said verification of correspondence by recovering said corresponding public signing key using a public signing key of a certification authority, generating a hash value for the received data block, generating a check signature based on the generated hash value and the recovered public signing key, and comparing the check signature and the provided signature of the data block.

48. The apparatus of claim 46, wherein said data block comprises a manifest describing implementing instructions of at least a subset of the functions/features of the removably attached interchangeable cover.

49. The apparatus of claim 37, wherein said instructions further enable the apparatus to authenticate said removably attached interchangeable cover by
generating a second challenge;
providing said second challenge to said removably attached interchangeable cover;
receiving from the removably attached interchangeable cover a second response to the second challenge; and
verifying correctness of said recovered second response.

50. The apparatus of claim 49, wherein said second challenge is based at least in part on said first response.

51. The apparatus of claim 50, wherein
said first challenge comprises providing the base portion with a manifest describing implementing instructions of at least a subset of the functions/features of the removably interchangeable cover and corresponding hash values, and a signature of the manifest;
said second challenge comprises providing the base portion with the described implementing instructions of at least one of functions/features of the removably attached interchangeable cover; and
said verification of the second response comprises generating a compare hash value for each of the at least one functions/features of the removably attached interchangeable cover provided, and comparing each of the generated compare hash values to the corresponding hash value previously provided as part of the signed manifest.

52. The apparatus of claim 36, wherein said instructions enable the apparatus to request and receive implementing instructions/data of a personalization feature from the removably attached interchangeable cover to personalize the electronic apparatus.

53. The apparatus of claim 36, wherein said instructions enable the apparatus to request and receive implementing instructions/data of a function from the removably attached interchangeable cover to enrich the functions of the electronic apparatus.

54. The apparatus of claim 36, wherein said instructions enable the apparatus to include as part of said enabling/disabling, disabling of functions/features previously loaded into the base portion that are to be enabled only with the presence of particular interchangeable covers.

55. The apparatus of claim 36, wherein s said instructions enable the apparatus to include as part of said enabling/disabling, disabling of selected ones of the functions/features of the base portion if the removably attached interchangeable cover is not authenticated.

56. The apparatus of claim 36, wherein said apparatus is a wireless communication device.

57. The apparatus of claim 56, wherein wireless communication device is a wireless mobile phone.

58. The apparatus of claim 36, wherein said electronic apparatus is a selected one of a personal digital assistant and an electronic gaming device.

59. A cover for an electronic apparatus, comprising:
a cover body to cover a base portion of the electronic apparatus;
a processor disposed on a surface of the cover body for use to execute instructions;
storage medium disposed on a surface of the cover body, coupled to said processor, and having stored therein data and a plurality of instructions designed to authenticate the interchangeable cover to a base portion of an electronic apparatus to which the interchangeable cover is attached.

60. The cover of claim 59, wherein the instructions are designed to enable the cover
to receive a first challenge from a base portion of an electronic apparatus to which to interchangeable cover is removable attached, to facilitate the base portion in determining that the interchangeable cover is an eligible cover; and
in response, to generate and provide the base portion with a first response to said first challenge to facilitate the base portion in making said determination.

61. The cover of claim 60, wherein said first challenge is received in a first encrypted form, and instructions enable the cover to decrypt said first challenge using a set of one or more session keys.

62. The cover of claim 61, wherein said instructions further enable the cover to pre-receive said set of one or more session keys from the base portion.

63. The cover of claim 62, wherein said set of one or more session keys are received in a second encrypted form, and said instructions further enable the cover to decrypt to recover said set of one or more session keys using a private key of the removably attached interchangeable cover corresponding to a public key of the removably attached interchangeable cover employed by the base portion to encrypt said set of one or more session keys.

64. The cover of claim 63, wherein said instructions further enable the cover to
receive a request from the base portion for and said public key of the removably attached interchangeable cover; and
in response, to provide said public key of the removably attached interchangeable cover to the base portion.

65. The cover of claim 64, wherein said instructions further enable the cover to provide said public key of the removably attached interchangeable cover in a signed form, signed by an authorized party using a signing key of a trusted certification authority.

66. The cover of claim 65, wherein the base portion of the electronic apparatus and the removably attached interchangeable cover are manufactured by a first and a second manufacturer respectively, and said trusted certification authority is a common licensor licensing respective manufacturing rights to said first and second manufacturers.

67. The cover of claim 65, wherein said instructions further enable the cover to effectuate said providing of said public key of the removably attached interchangeable cover by providing a certificate signed by said trusted certification authority comprising said public key of the removably attached interchangeable cover.

68. The cover of claim 60, wherein said first challenge comprises a challenge to provide the base portion with a data block and a signature of the data block, and said first response comprises the data block and the corresponding signature requested, the signature being pre-generated using a private signing key.

69. The cover of claim 68, wherein said data block comprises a manifest describing implementing instructions of at least a subset of the functions/features of the removably attached interchangeable cover.

70. The cover of claim 60, wherein said instructions further enable the cover to
receive a second challenge from the base portion to further facilitate said base portion in determining eligibility of the interchangeable cover; and
in response, to provide the base portion with a second response to the second challenge to further facilitate said base portion in determining eligibility of the interchangeable cover.

71. The cover of claim 70, wherein said second challenge is based at least in part on said first response.

72. The cover of claim 71, wherein
said first challenge comprises providing the base portion with a manifest describing implementing instructions of at least a subset of the functions/features of the removably interchangeable cover and corresponding hash values, and a signature of the manifest; and
said second challenge comprises providing the base portion with the described implementing instructions of at least one of functions/features of the removably attached interchangeable cover.

73. The cover of claim 59, wherein said instructions further enable the cover to receive a request and in response, to provide implementing instructions/data of a personalization feature from the removably attached interchangeable cover to personalize the electronic apparatus.

74. The cover of claim 59, wherein said instructions further enable the cover to receive a request and in response, to provide implementing instructions/data of a function from the removably attached interchangeable cover to enrich the functions of the electronic apparatus.

75. The cover of claim 59, wherein said electronic apparatus is a wireless communication device.

76. The cover of claim 75, wherein wireless communication device is a wireless mobile phone.

77. The cover of claim 59, wherein said electronic apparatus is a selected one of a personal digital assistant and an electronic gaming device.
